(19) United States
(12) Patent Application Publication
(10) Pub. No.: US 2026/0050484 A1
(43) Pub. Date: Feb. 19, 2026

(54) DYNAMIC WORKLOAD PARTITIONING FOR A SYSTEM ON A CHIP (SOC)

(71) Applicant: QUALCOMM Incorporated, San Diego, CA (US)

(72) Inventors: Shruti HANUMANTHAIAH, Bangalore (IN); Tejaswini SHENOY, Bangalore (IN); Subbarao LANKA, Bangalore (IN)

(21) Appl. No.: 18/802,557

(22) Filed: Aug. 13, 2024

(51) Int. Cl. G06F 9/50

(52) U.S. Cl. CPC G06F 9/505

(57) ABSTRACT

Aspects of the disclosure are directed to dynamic workload partitioning. In accordance with one aspect, the disclosure includes a first system on a chip (SOC) configured to commence a use case execution using a baseline workload partition; and a controller coupled to the first SOC, the controller configured to determine if the baseline workload partition should be reallocated using a machine learning (ML) monitoring of system on a chip (SOC) temperatures.

### TECHNICAL FIELD

This disclosure relates generally to the field of information processing systems, and, in particular, to dynamic workload partitioning for a system on a chip (SOC) within an information processing system.

### BACKGROUND

Information processing systems may include multiple processing engines, processors or processing cores for a variety of user applications. An information processing system may include a central processing unit (CPU), a graphics processing unit (GPU), a digital signal processor (DSP), an image signal processor (ISP), a neural processing unit (NPU), etc., along with input/output interfaces, a hierarchy of memory units and associated interconnection databuses. In addition, the information processing system may include a plurality of peripheral devices which communicate with a processing engine using a plurality of high-speed interfaces. In one example, the information processing system may include one or more system on a chip (SOC), integrated circuits (IC) wherein each host a plurality of processing engines within a single chip. One operational constraint is that SOC temperature is determined by the dc power consumption of the SOC which depends on a dynamically varying workload. SOC functional operation requires dynamic thermal management and control where the SOC temperature is monitored and regulated by dynamic workload partitioning.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides dynamic workload partitioning. Accordingly, the present disclosure discloses an apparatus including: a first system on a chip (SOC) configured to commence a use case execution using a baseline workload partition; and a controller coupled to the first SOC, the controller configured to determine if the baseline workload partition should be reallocated using a machine learning (ML) monitoring of system on a chip (SOC) temperatures.

In one example, the controller is further configured to reallocate a first task from the first SOC and to transition from the baseline workload partition to a first reallocated workload partition. In one example, the apparatus further includes a second system on a chip (SOC) coupled to the controller, the second SOC configured to receive the first task from the first SOC. In one example, the controller is further configured to revise a workload partition using machine learning (ML) to match a previously known workload partition with a junction temperature and a skin temperature.

Another aspect of the disclosure provides a method including: determining if a baseline workload partition should be reallocated using a machine learning (ML) monitoring of system on a chip (SOC) temperatures; reallocating a first task from a first system on a chip (SOC) to a second SOC to transition from the baseline workload partition to a first reallocated workload partition; updating a thermal balance model to execute one or more reallocated tasks on the second SOC for a graphics use case; and revising a workload partition using machine learning (ML) to match a previously known workload partition with junction temperature and skin temperature.

In one example, the first SOC is more heavily loaded than the second SOC in the baseline workload partition. In one example, the first task is reallocated based on a thermal characteristic and a de power demand characteristic.

In one example, the method further includes determining if the baseline workload partition is the same or different to the previously known workload partition. In one example, the method further includes determining if the first reallocated workload partition should be reallocated using the ML monitoring of SOC temperatures.

In one example, the ML monitoring of SOC temperatures monitors a plurality of junction temperatures. In one example, the method further includes comparing at least one of the plurality of junction temperatures against a maximum junction temperature threshold. In one example, the ML monitoring of SOC temperatures monitors a plurality of skin temperatures. In one example, the method further includes comparing at least one of the plurality of skin temperatures against a maximum skin temperature threshold.

In one example, the method further includes reallocating a second task from the first SOC to the second SOC to transition from the first reallocated workload partition to a second reallocated workload partition. In one example, the method further includes determining if the second reallocated workload partition should be reallocated using the ML monitoring of SOC temperatures. In one example, the method further includes commencing a use case execution in a dual system on a chip (SOC) configuration using the baseline workload partition.

Another aspect of the disclosure provides a non-transitory computer-readable medium storing computer executable code, operable on a device including at least one processor and at least one memory coupled to the at least one processor, wherein the at least one processor is configured to implement dynamic workload partitioning, the computer executable code including: instructions for causing a computer to determine if a baseline workload partition should be reallocated using a machine learning (ML) monitoring of system on a chip (SOC) temperatures; instructions for causing the computer to reallocate a first task from a first system on a chip (SOC) to a second SOC to transition from the baseline workload partition to a first reallocated workload partition; instructions for causing the computer to update a thermal balance model to execute one or more reallocated tasks on the second SOC for a graphics use case; and instructions for causing the computer to revise a workload partition using machine learning (ML) to match a previously known workload partition with junction temperature and skin temperature.

In one example, the non-transitory computer-readable medium further includes instructions for causing the computer to determine if the baseline workload partition is the same or different to the previously known workload partition. In one example, the non-transitory computer-readable medium further includes instructions for causing the computer to determine if the first reallocated workload partition should be reallocated using the ML monitoring of SOC temperatures. In one example, the non-transitory computer-readable medium further includes instructions for causing the computer to reallocate a second task from the first SOC to the second SOC to transition from the first reallocated workload partition to a second reallocated workload partition.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example temperature profile for an augmented reality (AR) system on a chip (SOC).

FIG. 3 illustrates an example dc power consumption graph vs. junction temperature Tj.

FIG. 4 illustrates an example use case for a virtual reality (VR) head mounted device (HMD).

FIG. 5 illustrates an example dual system on a chip (SoC) system for augmented reality (AR) applications.

FIG. 6 illustrates an example dual system on a chip (SoC) system for virtual reality (VR) applications.

FIG. 7 illustrates an example flow chart for machine learning (ML)-based dynamic workload partitioning.

FIG. 8 illustrates an example dual system on a chip (SoC) system with dynamic workload redistribution.

FIG. 9 illustrates an example temperature profile graph for a baseline workload partition.

FIG. 10 illustrates an example temperature profile graph for a reallocated workload partition.

FIG. 11 illustrates an example flow diagram for implementing machine learning (ML)-based dynamic workload partitioning.

FIG. 12 illustrates a first example thermal balance model.

FIG. 13 illustrates a second example thermal balance model.

FIG. 14 illustrates a third example thermal balance model.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An information processing system, for example, a computing system with multiple slices (e.g., processing engines) or a system on a chip (SoC), uses multiple levels of coordination or synchronization. In one example, a slice may include a processing engine (i.e., a subset of the computing system) as well as associated memory units and other peripheral devices. In one example, execution of an application may be decomposed into a workload which is executed by multiple slices or multiple processing engines.

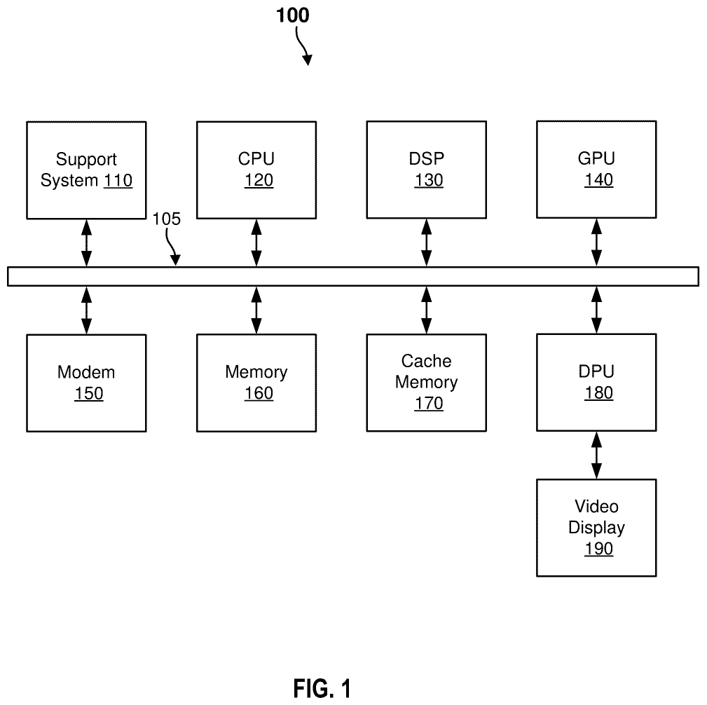

FIG. 1 illustrates an example information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. In one example, the CPU 120 may serve as a controller or a microcontroller of other processing engines. In one example, the controller or microcontroller may reallocate tasks from one processing engine to another. In one example, the controller or microcontroller may determine if a baseline workload partition should be reallocated using machine learning (ML) monitoring of system on a chip (SOC) temperatures.

In one example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines. Although several components of the information processing system 100 are included herein, one skilled in the art would understand that the components listed herein are examples and are not exclusive. Thus, other components may be included as part of the information processing system 100 within the spirit and scope of the present disclosure.

In one example, one or more processing engines in the information processing system 100 may be aggregated into a single integrated circuit known as a system on a chip (SOC). In one example, the SOC may include the central processing unit (CPU) 120 and other processing engines such as the DSP 130 or the GPU 140. The SOC may also include the memory 160 and the cache memory 170.

In one example, the information processing system 100 may be part of a wireless device in a wireless communication system. For example, the wireless communication system may conform to a wireless network protocol such as 4G LTE (long term evolution), 5G NR (new radio), etc.

In one example, a SOC workload may be dynamic. That is, the SOC workload may vary between a fully operational mode (e.g., maximum number of processing operations per unit time) to an idle mode (e.g., only standby operations). In one example, de power consumption of the SOC is directly dependent on the SOC mode. That is, the SOC may demand a higher dc power consumption when in a fully operational mode and may demand a lower de power consumption when in an idle mode. Since not all of the dc power consumption is converted to useful electronic energy for processing, much of the dc power consumption is converted into thermal energy. Thus, dynamic dc power consumption results in a variable thermal energy conversion which manifests as a time-varying SOC operational temperature profile.

In one example, active thermal management and control of the SOC may be required to maintain a SOC operational temperature T within a specified temperature range between a minimum operational temperature Tₘᵢₙ and a maximum operational temperature Tₘₐₓ. In one example, if the SOC operational temperature T is outside the specified temperature range (i.e., T<Tₘᵢₙ or T>Tₘₐₓ), appropriate thermal management may be performed to steer the SOC operational temperature T within the specified temperature range.

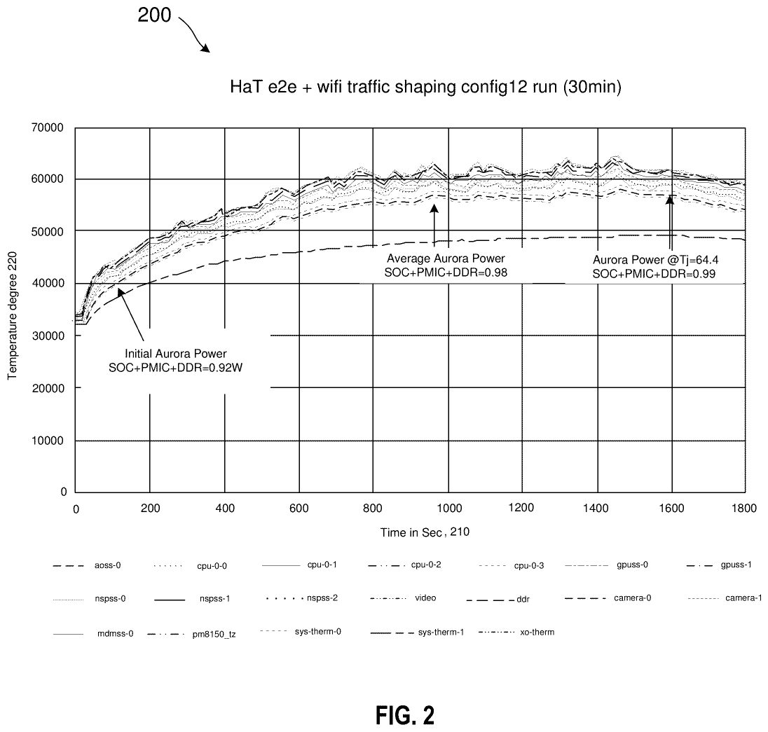

FIG. 2 illustrates an example temperature profile 200 for an augmented reality (AR) system on a chip (SOC). In one example, the temperature profile 200 shows time 210, in seconds, on a horizontal axis and temperature 220, in degrees C., on a vertical axis. In one example, skin temperature Tskin for AR glasses is an operational constraint with a typical maximum temperature threshold of 40 deg C. In one example, Tskin approaches its maximum temperature threshold with relatively low junction temperature Tj (e.g., Tj at 65 deg C.) which results in no margin for a thermal envelope.

In one example, there may be numerous excursions of the skin temperature Tskin while the junction temperature Tj may be approximately 65 deg C. which is well below the junction temperature maximum temperature threshold of 95 deg C. In one example, a thermal control design maintains the skin temperature Tskin below its maximum temperature threshold as well as minimizing the junction temperature Tj to constrain Tskin indirectly.

In one example, a virtual reality (VR) headset has stringent skin temperature Tskin constraints due to its proximity to human skin. For example, a VR head mounted device (HMD) may have a maximum allowable temperature between 40 deg C. and 45 deg C. which corresponds to a junction temperature Tj greater than 50 deg C. for several seconds. In one example, the VR HMD allows a limited thermal envelope.

In one example, a high junction temperature Tj impacts total dc power consumption of the SOC since leakage power and dynamic power increases. In one example, a usable dynamic power current is limited which constrains overall performance. In one example, since total de power increases exponentially with junction temperature Tj, the junction temperature Tj needs to be limited to prevent a performance degradation.

In one example, cooling techniques, such as heatsinks and fans, may be used for thermal mitigation. However, in one example, such cooling techniques add bulk to the virtual reality (VR) head mounted device (HMD) and increase dc power consumption (e.g., 1 W per fan) which affects usable battery life per charge cycle. Therefore, a thermal control technique without performance degradation and without additional dc power consumption may be desired. In one example, a thermal control technique may utilize a different workload and a changed thermal dissipation technique in a dual SOC configuration.

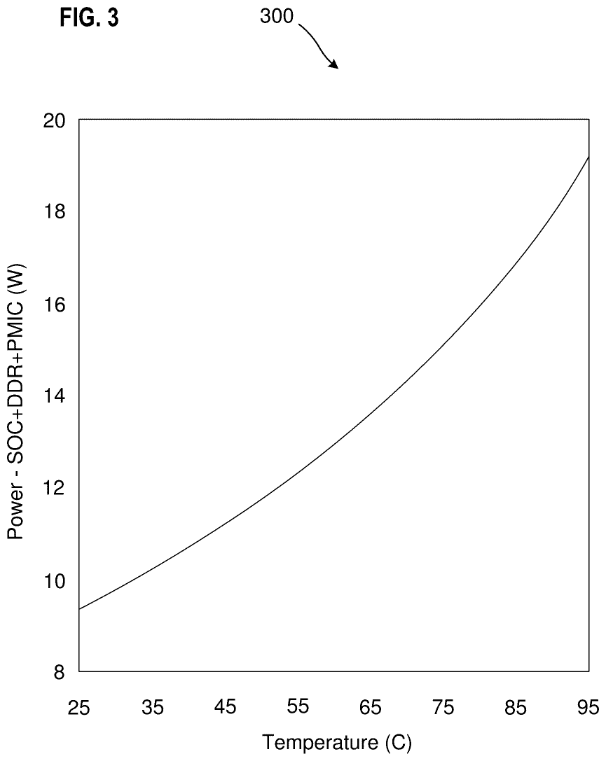

FIG. 3 illustrates an example dc power consumption graph vs. junction temperature Tj 300. In one example, the dc power consumption increases exponentially with junction temperature Tj which shows the need for limiting the junction temperature Tj to avoid an adverse thermal impact.

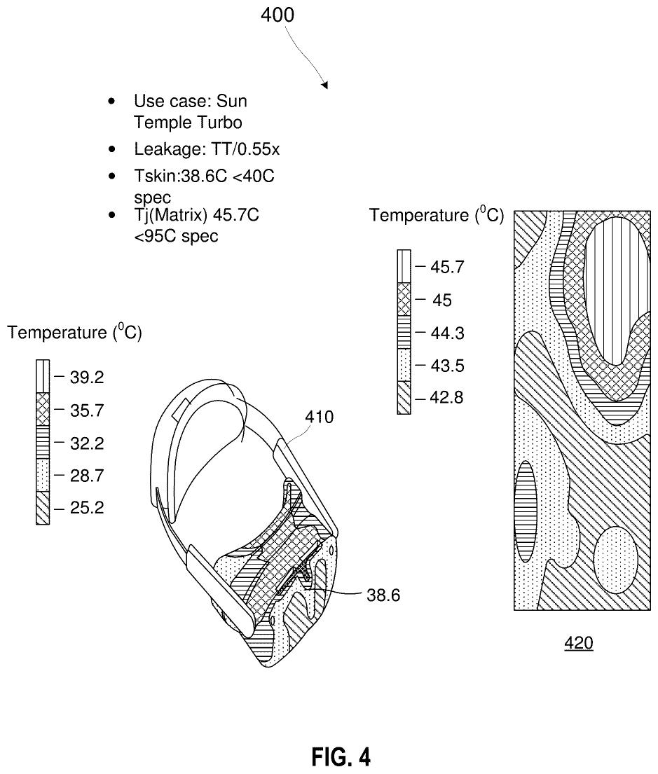

FIG. 4 illustrates an example use case for a virtual reality (VR) head mounted device (HMD) 400. In one example, the VR HMD thermal profile 410 is shown graphically with a maximum skin temperature of 38.6 deg C. compared to a maximum skin temperature threshold of 40 deg C. In one example, a SOC thermal profile 420 is shown graphically with a maximum junction temperature of 45.7 deg C. compared to a maximum junction temperature threshold of 95 deg C. In this example use case, the skin temperature Tskin closely tracks the junction temperature Tj. In one example, this tracking behavior implies that the junction temperature Tj should be allowed to increase closer to the maximum junction temperature threshold of 95 deg C. for optimal performance without being constrained by the skin temperature threshold of 40 deg C.

In one example, Table 1 summarizes thermal control design approaches for augmented reality (AR) and virtual reality (VR) devices.

TABLE 1
Thermal control design approaches

| Type | Device | Thermal control design | Details |
|---|---|---|---|
| tradi- | AR | Single SOC with thermal | AR glasses have |
| tional | | cooling material: thermal | materials for heat |
| | | paint, copper/graphite heat | distribution but with |
| | | spreaders, etc. | limited surface area |
| tradi- | VR | Single SOC with thermal | VR system thermal |
| tional | | cooling material: thermal | design power (TDP) |
| | | paint, copper/graphite heat | metric is higher than |
| | | spreaders, etc.; cooling | for AR (e.g., by 25 W). |
| | | fans (blowers) | Hence, active cooling |
| | | with heat pipes | devices needed (e.g., |
| | | | fans, heat pipes) |
| Dual | AR | Dual SOC with static work- | Dual SOC approach |
| SOC | | load distribution (plus | driven by improved |
| | | above features) | power and thermal |
| | | | distribution. |
| Dual | VR | Dual SOC with static work- | Dual SOC approach |
| SOC | | load distribution (plus | driven by optimization |
| | | above features) | of mass/area and |
| | | | performance |
| | | | enhancement which |
| | | | improves thermal |
| | | | distribution. |

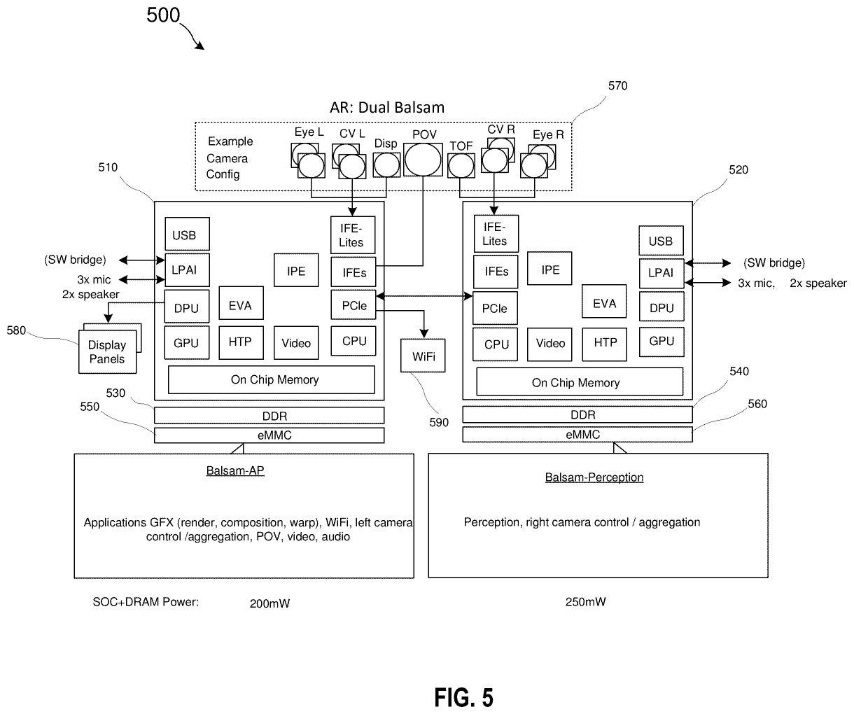

FIG. 5 illustrates an example dual system on a chip (SoC) system 500 for augmented reality (AR) applications. In one example, the dual SOC system 500 includes a first SOC 510, a second SOC 520, a first main memory 530, a second main memory 540, a first embedded multimedia card (eMMC) 550, a second eMMC 560, a camera configuration 570, a plurality of display panels 580 and a wireless modem 590. In one example, the first SOC 510 executes a first plurality of AR applications such as graphics (GFX) (e.g., render, composition, warp), wireless modem communications, left camera control and aggregation, point of view (POV) camera, video, audio, etc.). In one example, the second SOC 520 executes a second plurality of AR applications such as perception, right camera control and aggregation, etc. One skilled in the art would understand that the example AR applications listed herein are not exclusive and that other AR application examples may also be within the scope and spirit of the present disclosure.

In one example, the first SOC 510 is coupled to the first main memory 530 and the first eMMC 550. In one example, the second SOC 520 is coupled to the second main memory 540 and the second eMMC 560. In one example, the first SOC 510 and the second SOC 520 are coupled via a peripheral component interface express (PCIe) interface.

In one example, the first SOC 510 is coupled to the plurality of display panels 580 via an embedded display processing unit (DPU). In one example, the first SOC 510 is coupled to a first plurality of audio peripherals (e.g., microphones, speakers, etc.) via a first low power artificial intelligence (LPAI) interface. In one example, the first SOC 510 is coupled to the camera configuration 570 via an image front end (IFE) interface.

In one example, the second SOC 520 is coupled to a second plurality of audio peripherals (e.g., microphones, speakers, etc.) via a second low power artificial intelligence (LPAI) interface. In one example, the second SOC 520 is coupled to the camera configuration 570 via a second image front end (IFE) interface.

In one example, the dual SOC system 500 enhances de power management, thermal envelope control and performance, as well as improving product mass distribution and product packaging.

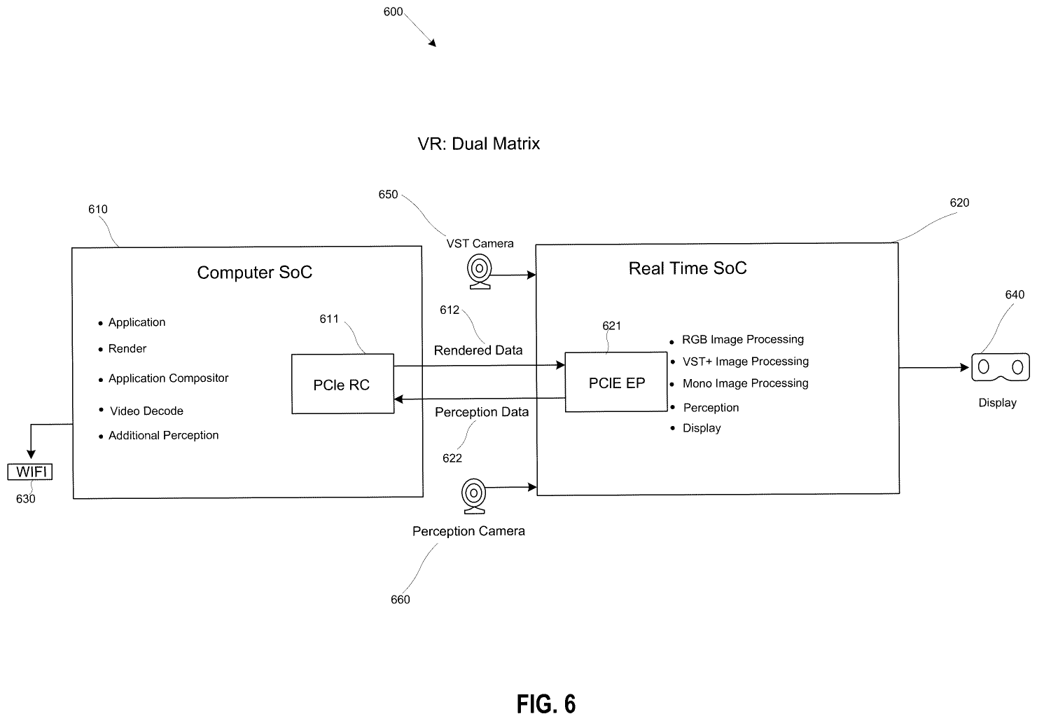

FIG. 6 illustrates an example dual system on a chip (SoC) system 600 for virtual reality (VR) applications. In one example, the dual SOC system 600 includes a first SOC 610 (e.g., a compute SOC) and a second SOC 620 (e.g., a real time SOC). In one example, the first SOC 610 executes a first plurality of VR applications such as applications, render, composition, video decoding, perception, etc. In one example, the second SOC 620 executes a second plurality of VR applications such as image processing, perception, display, etc. One skilled in the art would understand that the example VR applications listed herein are not exclusive and that other VR application examples may also be within the scope and spirit of the present disclosure.

In one example, the first SOC 610 is coupled to a wireless modem 630. In one example, the second SOC 620 is coupled to a display 640, to a first camera 650 and to a second camera 660. In one example, the first SOC 610 includes a PCI root port (RP) 611 and the second SOC 620 includes a PCIe endport (EP) 621. In one example, the PCI RP 611 sends rendered data 612 to the PCIe EP 621. In one example, the PCIe EP 621 sends perception data 622 to the PCI RP 611.

In one example, the dual SOC system 600 enhances dc power management, thermal envelope control and performance, as well as improving product mass distribution and product packaging.

In one example, existing SOC systems are performance-limited by thermal constraints. In one example, the following Table 2 illustrates a plurality of performance features for two example SOC systems. Table 2 shows that existing thermal solutions are not adequate for meeting many dc power and thermal requirements for a SOC system.

TABLE 2
Performance features for two example SOC systems

| Performance | Example SOC system 1- | Example SOC system 2- |
|---|---|---|
| feature | single SOC | dual SOC |
| Performance/ | VR: video see through | VR: improves VST P2P |
| form factor | (VST) is not competitive. | latency, extra GPU |
| | Not enough compute | headroom; |
| | horsepower for premium | AR: meets AR viewer |
| | tier services (e.g. 4k | performance requirements |
| | rendering/composition, | for all AR viewer modes |
| | multitask, high resolution | |
| | VST, perception); | |
| | AR: not all AR viewer | |
| | modes viable, package size | |
| | violation with additional | |
| | processing cores | |
| Latency | VR: lower latency; all | VR: higher latency; |
| | processing in single SOC; | For MR productivity use |
| | For MR productivity use | case M2R2P latency ~30 |
| | case motion to render to | ms; increased latency due |
| | platform (M2R2P) latency | to data transfer from RT |
| | is ~19 ms | SOC to Compute SOC to |
| | | RT SOC to display |
| Power | Lower power relative to | Execution in dual SOC |
| | dual SOC | requires infrared (IR) |
| | | power, PMIC quiescent |
| | | power, main memory |
| | | power overhead |
| Thermal | Processing cores run at | Better thermal distribution |
| | higher process corners to | relative to single SOC due |
| | meet performance reqts. | to workload distribution; |
| | which leads to higher Tj and | Workload distribution is |
| | Tskin; Tj and Tskin limits | static and is performance |
| | performance and restricts | driven, not optimized for |
| | application run time | thermal criteria |
| Thermal | Costly thermal solutions | Costly thermal solutions |
| solution | required; dual fans | required; dual fans |
| | required- fan cost, | required- fan cost, |
| | increased dc power (e.g., up | increased dc power (e.g., |
| | to 1.1 W) and noise higher | up to 1.1 W) and noise |
| | for premium applications | higher for premium |
| | | applications |

In one example, dynamic workload partitioning may improve dc power and thermal performance for a SOC system. In one example, a dynamic partition of SOC workload between a plurality of SOCs may be performed based on a given thermal scenario. In a first thermal scenario where two SOCs are each executing certain workloads, if a first SOC approaches a thermal limit (e.g., Tj or Tskin) and if a second SOC still has a positive thermal margin, then a portion of the first workload from the first SOC may be transferred to the second SOC until thermal conditions on the first SOC are within its thermal limits.

In a second thermal scenario where a first SOC is executing its workload while meeting its latency and dc power requirements without any other active SOCs, if the first SOC approaches its thermal limits, then a second SOC may be activated to offload a portion of its workload such that the system thermal envelope may be increased or fan activation may be delayed or set with a lower fan speed (e.g., for VR applications), thus optimizing dc power performance.

In one example, dynamic workload partitioning extends a thermal envelope for a SOC system. For example, the skin temperature Tskin for AR glasses or VR HMDs may be very crucial and have a relatively low temperature threshold (e.g., approximately 40 deg C.). In one example, the skin temperature Tskin may hit its maximum temperature limit with a relatively low junction temperature Tj of around 65 deg C. for AR and around 50 deg C. for VR which results in a very small thermal envelope. In one example, dynamic thermal control may extend an operational time for the junction temperature Tj and the skin temperature Tskin which permits improved thermal performance for a SOC system.

In one example, for VR applications, usage of dynamic workload partitioning reduces a duty cycle of cooling fans (e.g., fans have a delayed turn on or use a lower fan speed) relative to usage of static thermal control. As a consequence, fan de power consumption may be reduced, fan noise may be attenuated and fan size and quantity may be reduced (e.g., lower cost and reduced form factor). In one example, dynamic thermal control may be used for other applications such as wearable devices, automotive devices, etc.

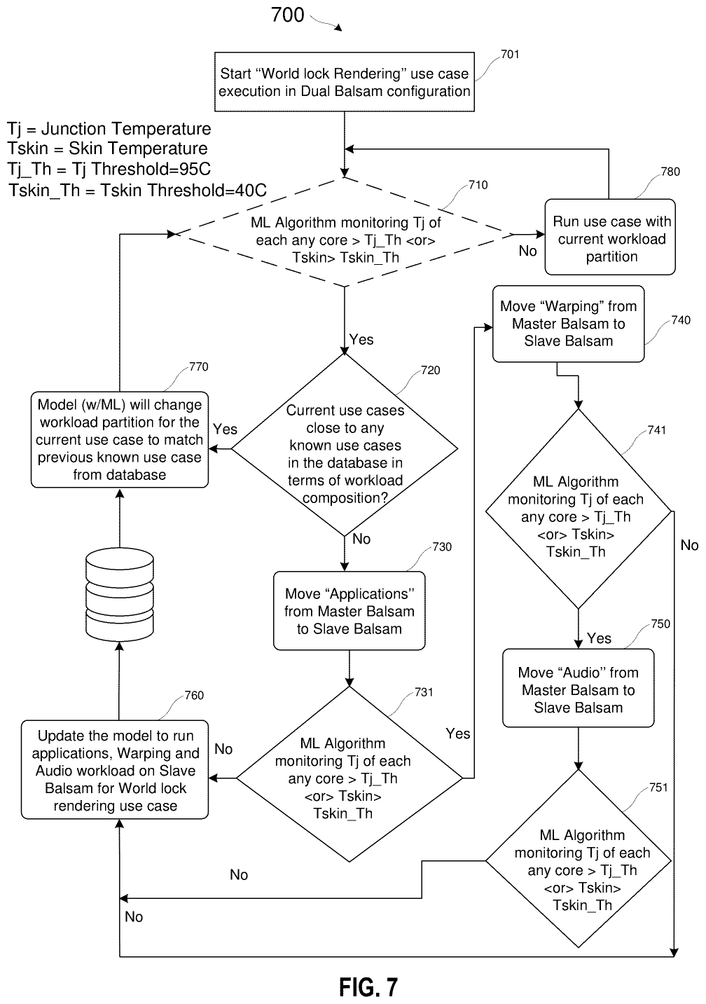

FIG. 7 illustrates an example flow chart 700 for machine learning (ML)-based dynamic workload partitioning. In block 701, start execution of a graphics use case in a dual SOC configuration with a baseline workload partition. In one example, the baseline workload partition includes a first plurality of baseline tasks in a first SOC and a second plurality of baseline tasks in a second SOC. In block 710, determine if any junction temperature (Tj) measurements exceed a junction temperature threshold Tj_th or if any skin temperature (Tskin) measurements exceed a skin temperature threshold Tskin_th for the baseline workload partition using machine learning (ML) monitoring. If at least one junction temperature measurement exceeds the junction temperature threshold or if at least one skin temperature measurement exceeds the skin temperature threshold, then proceed to block 720. Otherwise, proceed to block780.

In block 720, determine if the baseline workload partition is the same or comparable to one previously known workload partition using machine learning (ML) with a thermal balance model. If yes, proceed to block 770. If not, proceed to block 730. In one example, the determination of the same or comparable to one previously known workload partition may be based on a total count of use case category matching between two partitions relative to a predefined matching threshold value. In one example, the predefined matching threshold value is 70%. In one example, the predefined matching threshold value is 80%. In one example, the ML is an adaptive learning sequence based on use case category matching between two partitions relative to a predefined matching threshold value. In one example, the adaptive learning sequence uses the thermal balance model to determine the revised workload partition. In one example, the thermal balance model is a workload-based model. In one example, the thermal balance model is a use case/core comparison-based model. In one example, the thermal balance model is a core junction temperature/peak current based-model.

In block 730, reallocate a first task from the first plurality of baseline tasks from the first SOC to the second SOC to transition from the baseline workload partition to a first reallocated workload partition. In one example, the first task may be an Applications task. In one example, the first task is reallocated based on its thermal and de power demand characteristics.

In block 731, determine if any junction temperature (Tj) measurements exceed a maximum junction temperature threshold Tj_th or if any skin temperature (Tskin) measurements exceed a maximum skin temperature threshold Tskin_th for the first reallocated workload partition using ML monitoring. If at least one junction temperature measurement exceeds the maximum junction temperature threshold or if at least one skin temperature measurement exceeds the maximum skin temperature threshold, then proceed to block 740. Otherwise, proceed to block 760.

In block 740, reallocate a second task from the first plurality of baseline tasks from the first SOC to the second SOC to transition from the first reallocated workload partition to a second reallocated workload partition. In one example, the second task may be a graphics warping task.

In block 741, determine if any junction temperature (Tj) measurements exceed a maximum junction temperature threshold Tj_th or if any skin temperature (Tskin) measurements exceed a maximum skin temperature threshold Tskin_th for the second reallocated workload partition using ML monitoring. If at least one junction temperature measurement exceeds the maximum junction temperature threshold or if at least one skin temperature measurement exceeds the maximum skin temperature threshold, then proceed to block 750. Otherwise, proceed to block 760.

In block 750, reallocate a third task from the first plurality of baseline tasks from the first SOC to the second SOC to transition from the second reallocated workload partition to a third reallocated workload partition. In one example, the third task may be an audio task.

In block 751, determine if any junction temperature (Tj) measurements exceed a maximum junction temperature threshold Tj_th or if any skin temperature (Tskin) measurements exceed a maximum skin temperature threshold Tskin_th for the third reallocated workload partition using ML monitoring. If at least one junction temperature measurement exceeds the maximum junction temperature threshold or if at least one skin temperature measurement exceeds the maximum skin temperature threshold, then continue with additional reallocation of tasks from the first plurality of baseline tasks from the first SOC to the second SOC. Otherwise, proceed to block 760.

In block 760, update the thermal balance model to execute reallocated tasks on the second SOC for the graphics use case. In one example, the thermal balance model is a workload-based model. In one example, the thermal balance model is a use case/core comparison-based model. In one example, the thermal balance model is a core junction temperature/peak current based-model.

In block 770, revise workload partition using machine learning (ML) to match previously known workload partition with junction temperature and skin temperature. In one example, the ML is an adaptive learning sequence based on use case category matching between two partitions relative to a predefined matching threshold value. In one example, the adaptive learning sequence uses the thermal balance model to determine the revised workload partition.

In block 780, continue execution of the graphics use case in the dual SOC configuration with the baseline workload partition. In one example, repeat iteration loop by returning to block 710.

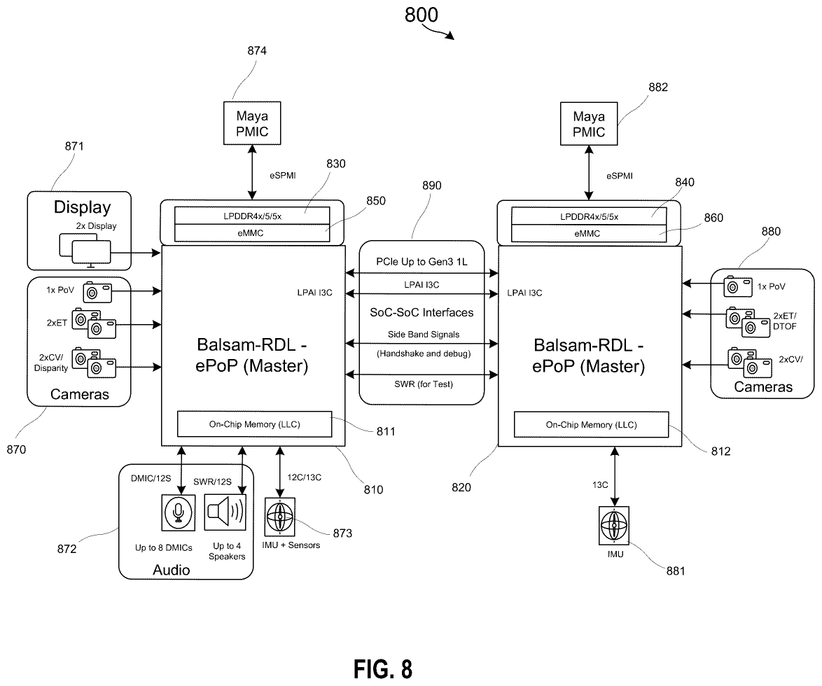

FIG. 8 illustrates an example dual system on a chip (SoC) system 800 with dynamic workload redistribution. In one example, the dual SOC system 800 includes a first SOC 810 coupled to a first on-chip memory 811, a first main memory 830 and a first embedded multimedia card (eMMC) 850. In one example, the dual SOC system 800 includes a second SOC 820 coupled to a second on-chip memory 812, a second main memory 840 and a second eMMC 860. In one example, the first SOC 810 is coupled to a first plurality of cameras 870, a display unit 871, a plurality of audio components 872, a first inertial measurement unit (IMU) sensor 873 and a first power management integrated circuit (PMIC) 874. In one example, the second 820 is coupled to a second plurality of cameras 880, a second IMU sensor 881 and a second PMIC 882. In one example, the first SOC 810 and the second SOC 820 are coupled via a plurality of SOC-SOC interface lines.

In one example, dynamic workload redistribution transitions the dual SOC system from a baseline workload partition to a reallocated workload partition by reallocating tasks from the first SOC 810 to the second SOC 820. In one example, the baseline workload partition may include the following tasks for the first SOC 810: applications, graphics (render, composition, warp), wireless modem, left camera control/aggregation, point of view (POV) camera, video and audio. In one example, the baseline workload partition may include the following tasks for the second SOC 820: perception and right camera control/aggregation. In one example, the baseline workload partition is selected for best performance and de power consumption.

In one example, the reallocated workload partition may redistribute the following tasks of the baseline workload partition from the first SOC 810 to the second SOC 820: applications, graphics and audio. In one example, the redistribution offloads some tasks from the first SOC 810 to the second SOC 820 when the first SOC 810 approaches its thermal threshold and continues until the first SOC 810 temperatures are within their thermal thresholds. In one example, the reallocated workload partition is selected for improved thermal balancing between the first SOC 810 and the second SOC 820. In one example, for AR applications, there may not be active coolers (e.g., fans) such that workload reallocation for improved thermal balancing may be critical for proper operation.

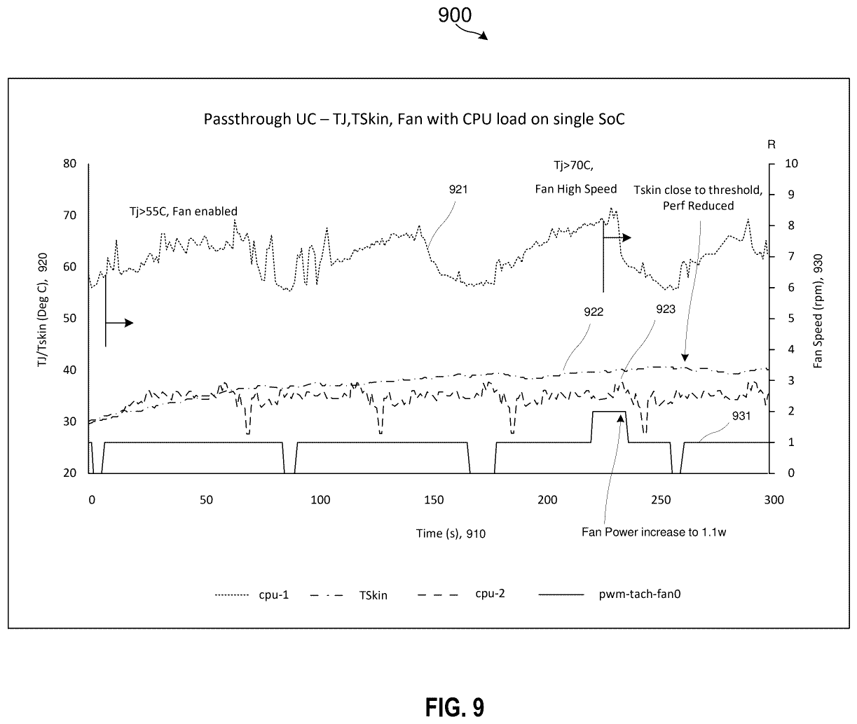

FIG. 9 illustrates an example temperature profile graph 900 for a baseline workload partition. In one example, the temperature profile graph 900 shows time 910, in seconds, on a horizontal axis, temperature 920, in degrees C., on a first vertical axis and fan speed 930, in revolutions per minute (rpm), on a second vertical axis.

In one example, the temperature profile graph 900 shows a first junction temperature 921 from a first SOC over time 910. In one example, as the first junction temperature 921 exceeds a first fan threshold (e.g., 55 deg C.), a fan is enabled at a low fan speed. In one example, as the first junction temperature 921 exceeds a second fan threshold (e.g., 70 deg C.), the fan is enabled at a high fan speed.

In one example, the temperature profile graph 900 shows a skin temperature 922 from the first SOC over time 910. In one example, the skin temperature 922 approaches a skin temperature threshold (e.g., 40 deg C.) and performance may be degraded. In one example, the first junction temperature 921 and the skin temperature 922 increase over time due to the baseline workload partition for the first SOC. In one example, performance may be degraded due to operational mitigations in the first SOC at a high junction temperature. In one example, dc power consumption increases exponentially with junction temperature in the first SOC.

In one example, the temperature profile graph 900 shows a second junction temperature 923 from a second SOC over time 910. In one example, the second junction temperature 923 is close to a nominal temperature (e.g., 30 deg C.) since the second SOC is minimally loaded.

In one example, the temperature profile graph 900 shows a fan tachometer speed 931 from the first SOC over time 910. In one example, the fan tachometer speed 931 transitions from a low fan speed to a high fan speed when the first junction temperature 921 exceeds the second fan threshold (e.g., 70 deg C.) and while the fan dc power consumption increases to 1.1 W.

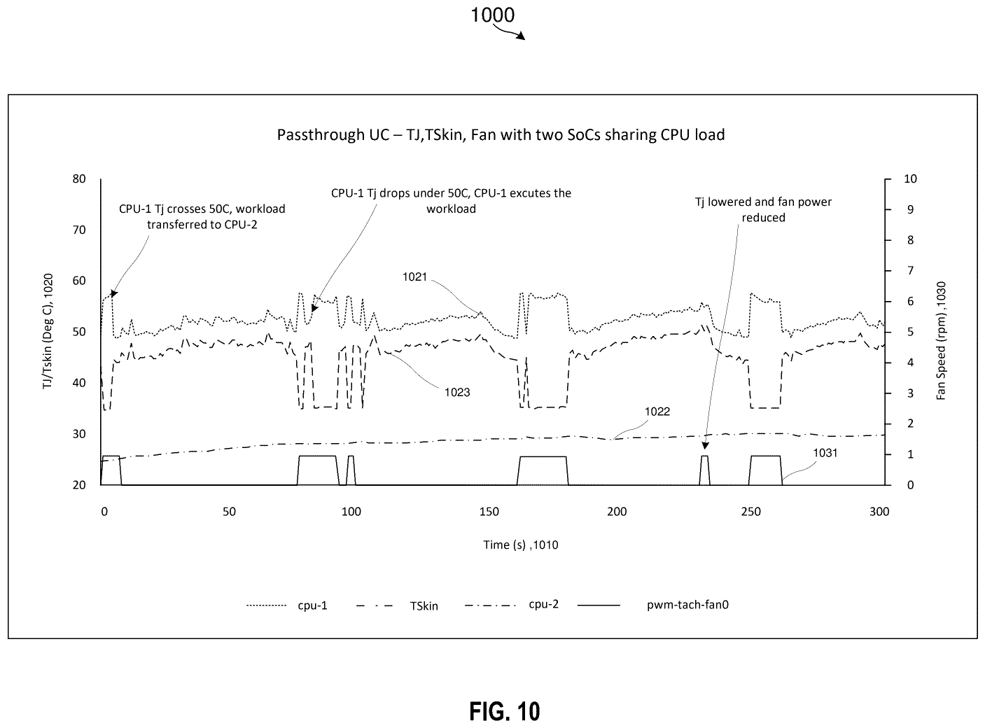

FIG. 10 illustrates an example temperature profile graph 1000 for a reallocated workload partition. In one example, the first temperature profile 1000 shows time 1010, in seconds, on a horizontal axis, temperature 1020, in degrees C., on a first vertical axis and fan speed 1030, in rpm, on a second vertical axis.

In one example, the temperature profile graph 1000 shows a first junction temperature 1021 from a first SOC over time 1010. In one example, the first junction temperature 1021 is maintained at a relatively lower temperature compared to the baseline workload partition of FIG. 9 due to the redistributed workload between the first SOC and a second SOC.

In one example, the temperature profile graph 1000 shows a skin temperature 1022 from the first SOC over time 1010. In one example, the skin temperature 1022 is maintained below a skin temperature threshold (e.g., 40 deg C.) and performance degradation is avoided.

In one example, the temperature profile graph 1000 shows a second junction temperature 1023 from the second SOC over time 1010. In one example, the second junction temperature 1023 is maintained close to a nominal temperature (e.g., 30 deg C.).

In one example, the temperature profile graph 1000 shows a fan tachometer speed 1031 from the first SOC over time 1010. In one example, the fan tachometer speed 1031 is at a low fan speed or is zero when the fan is off.

In one example, the temperature profile graph 1000 shows how dynamic thermal control maintains the skin temperature 1022 below the skin temperature threshold and reduces overall dc power consumption compared to the baseline work partition. In one example, the temperature profile graph 1000 also results in a lower fan dc power consumption compared to the baseline work partition.

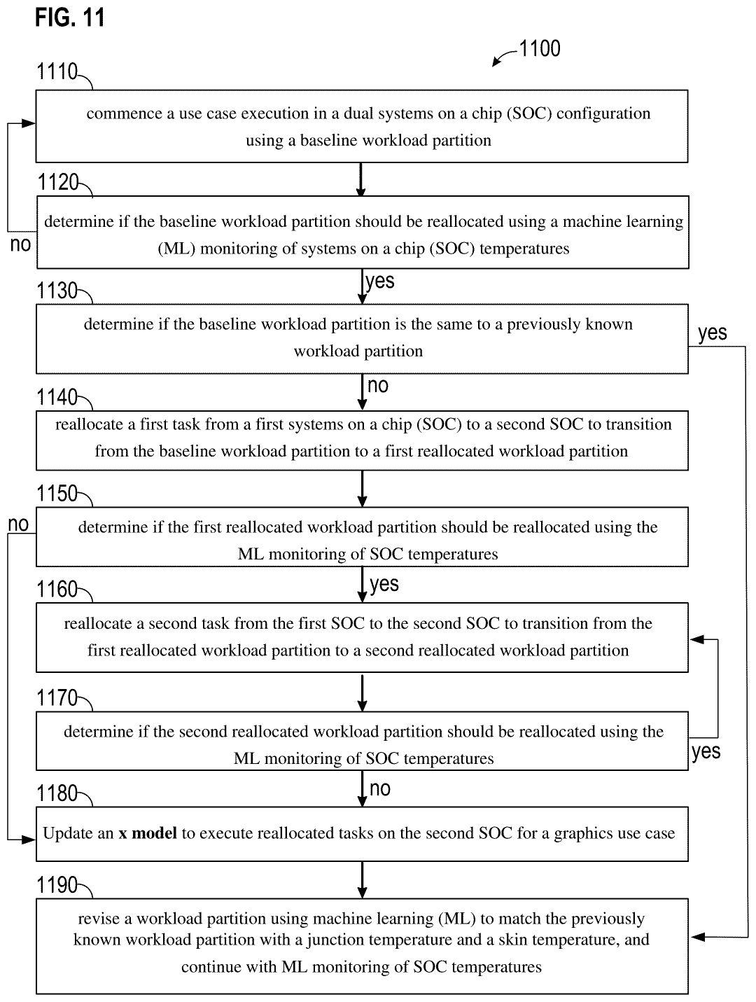

FIG. 11 illustrates an example flow diagram 1100 for implementing machine learning (ML)-based dynamic workload partitioning. In block 1110, commence a use case execution in a dual system on a chip (SOC) configuration using a baseline workload partition. In one example, a use case execution is commenced in a dual system on a chip (SOC) configuration using a baseline workload partition. In one example, the dual SOC configuration includes a first SOC and a second SOC. In one example, the first SOC is more heavily loaded than the second SOC in the baseline workload partition. In one example, the step of block 1110 is performed by a system on a chip (SOC) (e.g., a first SOC 510 or a second SOC 520).

In block 1120, determine if the baseline workload partition should be reallocated using a machine learning (ML) monitoring of system on a chip (SOC) temperatures. If yes, proceed to block 1130. If no, continue execution of the graphics use case in the dual SOC configuration with the baseline workload partition by returning to block 1110. In one example, the baseline workload partition is determined to be reallocated or not using a machine learning (ML) monitoring of system on a chip (SOC) temperatures.

In one example, the ML monitoring of SOC temperatures monitors a plurality of junction temperatures. In one example, the ML monitoring of SOC temperatures monitors a plurality of skin temperatures. In one example, the ML monitoring of SOC temperatures includes comparison of at least one junction temperature against a maximum junction temperature threshold. In one example, the ML monitoring of SOC temperatures includes comparison of at least one skin temperature against a maximum skin temperature threshold. In one example, the step of block 1120 is performed by a power management integrated circuit (PMIC) (e.g., PMIC 874 or PMIC 882). In another example, the step of block 1120 is performed by a controller or a microcontroller.

In block 1130, determine if the baseline workload partition is the same to a previously known workload partition using machine learning (ML) with a thermal balance model. If yes, proceed to block 1190. If not, proceed to block 1140. In one example, the baseline workload partition is determined to be the same or different to a previously known workload partition. In one example, the previously known workload partition specifies an allocation of tasks among the first SOC and the second SOC. In one example, the determination of the same or comparable to a previously known workload partition may be based on a total count of use case category matching between two partitions relative to a predefined matching threshold value. In one example, the predefined matching threshold value is 70%. In one example, the predefined matching threshold value is 80%. In one example, the ML is an adaptive learning sequence based on use case category matching between two partitions relative to a predefined matching threshold value. In one example, the adaptive learning sequence uses the thermal balance model to determine the revised workload partition. In one example, the thermal balance model is a workload-based model. In one example, the thermal balance model is a use case/core comparison-based model. In one example, the thermal balance model is a core junction temperature/peak current based-model. In one example, the step of block 1130 is performed by a system on a chip (SOC) (e.g., a first SOC 510 or a second SOC 520).

In block 1140, reallocate a first task from a first system on a chip (SOC) to a second SOC to transition from the baseline workload partition to a first reallocated workload partition. In one example, a first task is reallocated from a first system on a chip (SOC) to a second SOC to transition from the baseline workload partition to a first reallocated workload partition. In one example, the first task may be an applications task. In one example, the first task is reallocated based on its thermal and dc power demand characteristics. In one example, the step of block 1140 is performed by a system on a chip (SOC) (e.g., a first SOC 510 or a second SOC 520). In another example, the step of block 1140 is performed by a controller or a microcontroller.

In block 1150, determine if the first reallocated workload partition should be reallocated using machine learning (ML) monitoring of SOC temperatures. If yes, proceed to block 1160. If no, proceed to block 1180. In one example, the first reallocated workload partition is determined to be reallocated or not using machine learning (ML) monitoring of SOC temperatures.

In one example, the ML monitoring of SOC temperatures monitors a plurality of junction temperatures. In one example, the ML monitoring of SOC temperatures monitors a plurality of skin temperatures. In one example, the ML monitoring of SOC temperatures includes comparison of at least one junction temperature against the maximum junction temperature threshold. In one example, the ML monitoring of SOC temperatures includes comparison of at least one skin temperature against the maximum skin temperature threshold. In one example, the step of block 1150 is performed by a power management integrated circuit (PMIC) (e.g., PMIC 874 or PMIC 882).

In block 1160, reallocate a second task from the first SOC to the second SOC to transition from the first reallocated workload partition to a second reallocated workload partition. In one example, a second task is reallocated from the first SOC to the second SOC to transition from the first reallocated workload partition to a second reallocated workload partition. In one example, the second task may be a graphics task (e.g., warping). In one example, the second task is reallocated based on its thermal and dc power demand characteristics. In one example, the step of block 1160 is performed by a system on a chip (SOC) (e.g., a first SOC 510 or a second SOC 520). In another example, the step of block 1160 is performed by a controller or a microcontroller.

In block 1170, determine if the second reallocated workload partition should be reallocated using the machine learning (ML) monitoring of SOC temperatures. In one example, the second reallocated workload partition is determined to be reallocated or not using the machine learning (ML) monitoring of SOC temperatures.

In one example, the ML monitoring of SOC temperatures monitors a plurality of junction temperatures. In one example, the ML monitoring of SOC temperatures monitors a plurality of skin temperatures. In one example, the ML monitoring of SOC temperatures includes comparison of at least one junction temperature against the maximum junction temperature threshold. In one example, the ML monitoring of SOC temperatures includes comparison of at least one skin temperature against the maximum skin temperature threshold. If yes, then continue with additional reallocation of tasks from the second reallocated workload partition. If no, proceed to block 1180. In one example, the step of block 1170 is performed by a power management integrated circuit (PMIC) (e.g., PMIC 874 or PMIC 882).

In block 1180, update the thermal balance model to execute reallocated tasks on the second SOC for a graphics use case. In one example, the thermal balance model is updated to execute reallocated tasks on the second SOC for a graphics use case. In one example, the thermal balance model is a workload-based model. In one example, the thermal balance model is a use case/core comparison-based model. In one example, the thermal balance model is a core junction temperature/peak current based-model. In one example, the step of block 1180 is performed by a system on a chip (SOC) (e.g., a first SOC 510 or a second SOC 520). In another example, the step of block 1180 is performed by a controller or a microcontroller.

In block 1190, revise a workload partition using machine learning (ML) to match the previously known workload partition with a junction temperature and a skin temperature, and continue with ML monitoring of SOC temperatures. In one example, a workload partition is revised using machine learning (ML) to match the previously known workload partition with a junction temperature and a skin temperature. In one example, the ML is an adaptive learning sequence based on use case category matching between two partitions relative to a predefined matching threshold value. In one example, the ML is an adaptive learning sequence based on use case category matching between two partitions relative to a predefined matching threshold value. In one example, the adaptive learning sequence uses the thermal balance model to determine the revised workload partition. In one example, the step of block 1190 is performed by a system on a chip (SOC) (e.g., a first SOC 510 or a second SOC 520). In another example, the step of block 1190 is performed by a controller or a microcontroller.

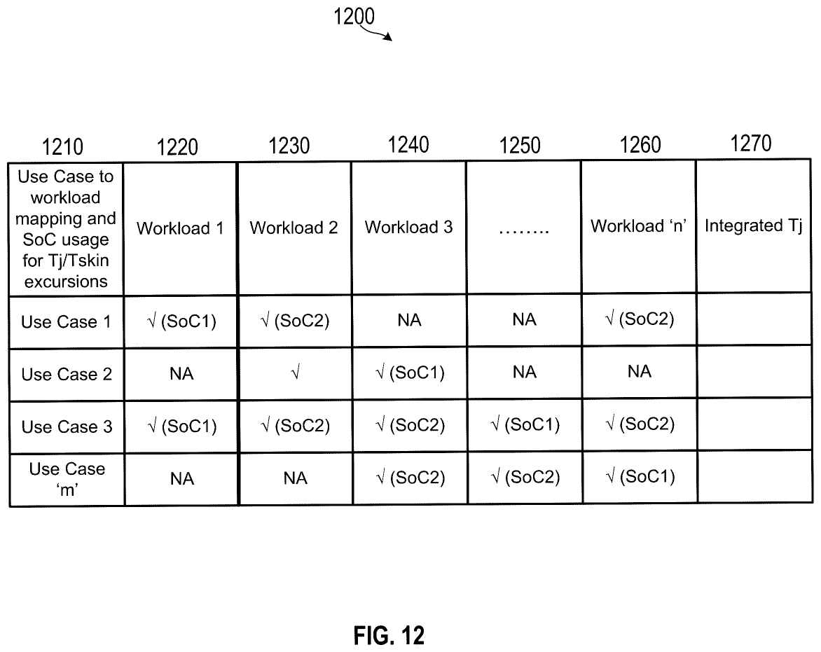

In one example, FIG. 12 illustrates a first example thermal balance model 1200. In one example, the first thermal balance model 1200 is a workload-based model. For example, the first thermal balance model 1200 includes a use case category 1210, a first workload category 1220, a second workload category 1230, a third workload category 1240, a fourth workload category 1250, a fifth workload category 1260 and an integrated junction temperature category 1270.

In one example, the first thermal balance model 1200 is a database which tabulates a quantity of M use cases and a quantity of N workloads. For example, the first thermal balance model 1200 contains a workload to use case mapping. For example, the M use cases include 720 pixel video streaming, world lock rendering, contextual artificial intelligence (AI), etc. For example, the N workloads include a perception algorithm, application software, warpage correction, composition, camera aggregation, etc. For example, the first thermal balance model 1200 also includes a use case to workload partitioning between a plurality of SoCs for temperature excursion cases.

In one example, upon execution of a new use case which is not included in the quantity of M use cases, a workload partition between the plurality of SoCs commences with a baseline partition. In one example, the baseline partition is a partition according to a software/hardware implementation of the new use case.

In one example, if a junction temperature exceeds a junction temperature threshold or a skin temperature exceeds a skin temperature threshold, an ML algorithm will determine if the new use case matches any existing use case listed in the use case category 1210 in terms of workload applicability. If there is a match, then the ML algorithm changes the baseline workload partition to match the comparable use case. If there is no match, one or more workloads may be reallocated from a first SoC to a second SoC to create a first reallocated partition. In one example, if the junction temperature and the skin temperature do not exceed their respective thresholds, after a predefined wait time, then execution of the new use case continues with the first reallocated partition. In one example, if either the junction temperature or the skin temperature exceeds their respective thresholds, continue reallocation of other workloads from the first SoC to the second SoC to create a second reallocated partition. In one example, the first thermal balance model 1200 is updated with the first reallocated partition or the second reallocated partition for junction temperature and skin temperature excursion cases.

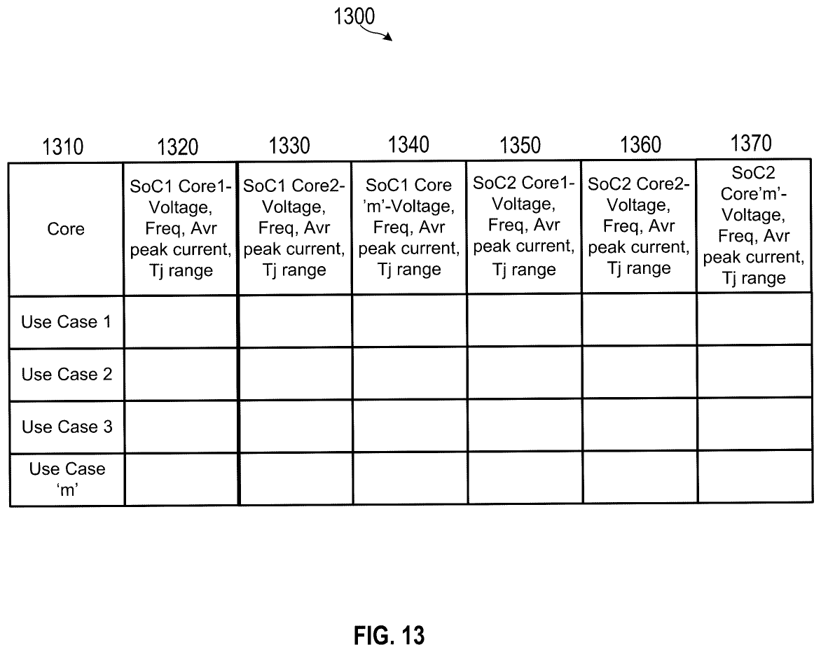

In one example, FIG. 13 illustrates a second example thermal balance model 1300. In one example, the second thermal balance model 1300 is a use case/core comparison-based model. For example, the second thermal balance model 1300 includes a use case category 1310, a first SoC1 category 1320, a second SoC1 category 1330, a third SoC1 category 1340, a first SoC2 category 1350, a second SoC2 category 1360 and a third SoC2 category 1370.

In one example, the second thermal balance model 1300 is a database which tabulates a quantity of M use cases and a quantity of N SoC configurations. In one example, a SoC configuration includes voltage, frequency, average peak current, junction temperature range, etc. For example, the second thermal balance model 1300 contains a SoC configuration to use case mapping.

In one example, if an ML algorithm finds no matches with a new use case in terms of workload for the first thermal balance model 1200, the ML algorithm may use the second thermal balance model 1300 with the SoC configuration to use case mapping to initialize with a baseline partition.

In one example, if the ML algorithm determines that the baseline partition matches one of the use cases listed in the use case category 1310, it will change the baseline workload partition to match the comparable use case to create a first reallocated partition. In one example, if the junction temperature and the skin temperature do not exceed their respective thresholds, after a predefined wait time, then execution of the use case continues with the first reallocated partition. Otherwise, a second reallocated partition is created. In one example, the second thermal balance model 1300 is updated with the first reallocated partition or second reallocated partition for junction temperature and skin temperature excursion cases.

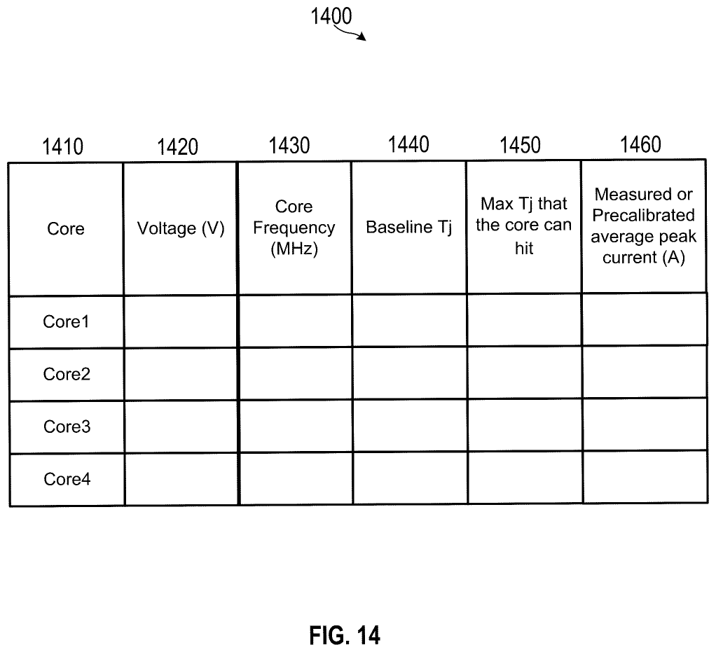

In one example, FIG. 14 illustrates a third example thermal balance model 1400. In one example, the third thermal balance model 1400 is a core junction temperature/peak current based-model. For example, the third thermal balance model 1400 includes a core category 1410, a core voltage category 1420, a core frequency category 1430, a baseline junction temperature category 1440, a maximum junction temperature category 1450 and an average peak current category 1460.

In one example, the third thermal balance model 1400 is a database which tabulates a quantity of M core cases and a quantity of N core parameters. For example, the third thermal balance model 1400 contains a core parameter to core case mapping.

In one example, if an ML algorithm finds no matches with a new use case in terms of workload for the first thermal balance model 1200 or the second thermal balance model 1300, the ML algorithm may use the third thermal balance model 1400 with the core parameter to core case mapping to initialize with a baseline partition.

In one example, the ML algorithm may perform a repartitioning based on the third thermal balance model 1400 to determine a set of voltage, core frequency, junction temperature and maximum junction temperature which achieves a desired average peak current. In one example, if the junction temperature and the skin temperature do not exceed their respective thresholds, after a predefined wait time, then execution of the use case continues with the first reallocated partition. Otherwise, a second reallocated partition is created. In one example, the third thermal balance model 1400 is updated with a first reallocated partition or the second reallocated partition for junction temperature and skin temperature excursion cases.

In one aspect, one or more of the steps for providing dynamic workload partitioning in FIG. 11 may be executed by one or more processors which may include hardware, software, firmware, etc. The one or more processors, for example, may be used to execute software or firmware needed to perform the steps in the flow diagram of FIG. 11. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
a first system on a chip (SOC) configured to commence a use case execution using a baseline workload partition; and
a controller coupled to the first SOC, the controller configured to determine if the baseline workload partition should be reallocated using a machine learning (ML) monitoring of system on a chip (SOC) temperatures.

2. The apparatus of claim 1, wherein the controller is further configured to reallocate a first task from the first SOC and to transition from the baseline workload partition to a first reallocated workload partition.

3. The apparatus of claim 2, further comprising a second system on a chip (SOC) coupled to the controller, the second SOC configured to receive the first task from the first SOC.

4. The apparatus of claim 3, wherein the controller is further configured to revise a workload partition using machine learning (ML) to match a previously known workload partition with a junction temperature and a skin temperature.

5. A method comprising:
determining if a baseline workload partition should be reallocated using a machine learning (ML) monitoring of system on a chip (SOC) temperatures;
reallocating a first task from a first system on a chip (SOC) to a second SOC to transition from the baseline workload partition to a first reallocated workload partition;
updating a thermal balance model to execute one or more reallocated tasks on the second SOC for a graphics use case; and
revising a workload partition using machine learning (ML) to match a previously known workload partition with junction temperature and skin temperature.

6. The method of claim 5, wherein the first SOC is more heavily loaded than the second SOC in the baseline workload partition.

7. The method of claim 5, wherein the first task is reallocated based on a thermal characteristic and a dc power demand characteristic.

8. The method of claim 5, further comprising determining if the baseline workload partition is the same or different to the previously known workload partition.

9. The method of claim 8, further comprising determining if the first reallocated workload partition should be reallocated using the ML monitoring of SOC temperatures.

10. The method of claim 9, wherein the ML monitoring of SOC temperatures monitors a plurality of junction temperatures.

11. The method of claim 10, further comprising comparing at least one of the plurality of junction temperatures against a maximum junction temperature threshold.

12. The method of claim 9, wherein the ML monitoring of SOC temperatures monitors a plurality of skin temperatures.

13. The method of claim 12, further comprising comparing at least one of the plurality of skin temperatures against a maximum skin temperature threshold.

14. The method of claim 9, further comprising reallocating a second task from the first SOC to the second SOC to transition from the first reallocated workload partition to a second reallocated workload partition.

15. The method of claim 14, further comprising determining if the second reallocated workload partition should be reallocated using the ML monitoring of SOC temperatures.

16. The method of claim 15, further comprising commencing a use case execution in a dual system on a chip (SOC) configuration using the baseline workload partition.

17. A non-transitory computer-readable medium storing computer executable code, operable on a device comprising at least one processor and at least one memory coupled to the at least one processor, wherein the at least one processor is configured to implement dynamic workload partitioning, the computer executable code comprising:
instructions for causing a computer to determine if a baseline workload partition should be reallocated using a machine learning (ML) monitoring of system on a chip (SOC) temperatures;
instructions for causing the computer to reallocate a first task from a first system on a chip (SOC) to a second SOC to transition from the baseline workload partition to a first reallocated workload partition;
instructions for causing the computer to update a thermal balance model to execute one or more reallocated tasks on the second SOC for a graphics use case; and
instructions for causing the computer to revise a workload partition using machine learning (ML) to match a previously known workload partition with junction temperature and skin temperature.

18. The non-transitory computer-readable medium of claim 17, further comprising instructions for causing the computer to determine if the baseline workload partition is the same or different to the previously known workload partition.

19. The non-transitory computer-readable medium of claim 18, further comprising instructions for causing the computer to determine if the first reallocated workload partition should be reallocated using the ML monitoring of SOC temperatures.

20. The non-transitory computer-readable medium of claim 19, further comprising instructions for causing the computer to reallocate a second task from the first SOC to the second SOC to transition from the first reallocated workload partition to a second reallocated workload partition.
